(19) United States
(12) Patent Application Publication
(10) Pub. No.: US 2017/0235708 A1
(43) Pub. Date: Aug. 17, 2017

(54) METHOD FOR DYNAMIC PLACEMENT OF CREATIVE CONTENT ON A WEB PAGE

(71) Applicant: Kiosked Oy, Espoo (FI)

(72) Inventor: Frans Ekman, Espoo (FI)

(21) Appl. No.: 15/042,714

(22) Filed: Feb. 12, 2016

(51) Int. Cl. G06F 17/22; H04L 29/12; G06Q 30/02; G06F 17/24; G06F 17/21; H04L 29/08; G06F 17/27

(52) U.S. Cl. CPC G06F 17/2247; H04L 67/02; H04L 61/2007; G06F 17/27; G06F 17/24; G06F 17/211; G06Q 30/0277

(57) ABSTRACT

Disclosed is a method for dynamically placing an advertisement on a web page. The method includes following steps of: (a) receiving a first request that includes context information from a device, (b) determining whether a light script that is suitable for the context information exists, (c) when the light script suitable for the context information exists, communicating the light script to the device, for placing the first advertisement on a webpage followed by receiving a second request that includes context information from the device, or when no light script that is suitable for the context information exists, (d) communicating a full script to the device for analyzing content of the web page and for analyzing the correctness of the placement of the first advertisement on the web page, and (e) receiving a placement report of the first advertisement from the device.

### TECHNICAL FIELD

The present disclosure relates generally to digital content transmission over the Internet; and more specifically, to a system and method for dynamically placing creative content on a web page.

### BACKGROUND

Billions of online advertisement impressions reach users on various computing devices every single day through web pages. Advertising technology, which is also known as ‘Ad Tech’, commonly refers to all technical or software solutions and services used for delivering, displaying, targeting and controlling the online advertisements. Advertisement servers (e.g., known as Ad servers) manage the display of advertisements on websites. The speed with which an advertisement is served on a web page from a server has a direct impact on the revenue of the advertiser, since more users will have a chance to see and possibly click on the advertisement if it is rendered quickly. The speed for serving the first set of advertisements is particularly important, since by the time the user has scrolled down, the last advertisements will already have been loaded. The first set of advertisements are hence given special importance in advertising, and are also known as “Above the fold ads” to indicate that they are rendered on a top portion of a webpage that is visible without the user having to scroll down.

The process by which online advertising is displayed can involve many parties. In the simplest case, the web site publisher selects and serves the advertisements or creative content. More often publishers use ad servers and/or ad networks to manage the ad mediation. In this case, most often publishers may mark placements statically in their hyper text markup language code or put different ‘ad tags’ in each place in the hyper text markup language code where an advertisement is to be shown. This is known as static placement, and it requires effort from publishers and implicitly reduces flexibility related to web page design, as advertisement sizes have to be mostly defined a priori. Alternatively, a server may transmit a script that sniffs the best locations on the web page dynamically in the client, utilizing javascript code executed by the client's in the browser, so that these locations need not be pre-configured by the publishers. For the locations that the script has sniffed, it may either draw the advertisements directly or it may insert other tags in them. This process is known as dynamic placement. In the case of dynamic placement, some additional delay will always be introduced since the code to implement the sniffing logic also has to be transmitted to the client device from the server. In order to support a variety of differently constructed websites, plenty of complex logic is needed, thus causing further delays in transmission, and losses of revenue. Additionally, the actual sniffing may be a complex slow operation on heavy websites, introducing even further delays.

Therefore, in light of the foregoing discussion, there exists a need to overcome the aforementioned drawbacks in existing approaches for serving scripts to client devices for dynamic placement of creative content.

### SUMMARY

The present disclosure seeks to provide a method for dynamically placing an advertisement on a web page. The method includes following steps of: (a) receiving a first request that includes context information from a device, (b) determining whether a light script that is suitable for the context information exists, (c) when the light script suitable for the context information exists, communicating the light script to the device, for placing the first advertisement on the webpage followed by receiving a second request that includes context information from the device, or when no light script that is suitable for the context information exists, (d) communicating a full script to the device for analyzing content of the web page and for analyzing the correctness of the placement of the first advertisement on the web page, and (e) receiving a placement report of the first advertisement from the device. The light script is configured to place at least the first advertisement on the web page to be displayed on the device.

The present disclosure seeks to provide one or more non-transitory computer readable storage mediums storing one or more sequences of instructions, which when executed by one or more processors, causes dynamically placing an advertisement on a web page, the instructions being configured to perform the steps of: (a) receiving a first request that comprises context information from a device, (b) determining whether a light script that is suitable for the context information exists, based on the context information, (c) when the light script suitable for the context information exists, communicating the light script to the device, for placing the first advertisement on the web page followed by receiving a second request that includes context information from the device, or when no light script that is suitable for the context information exists, (d) communicating a full script to the device for analyzing content of the web page and for analyzing the correctness of the placement of the first advertisement on the web page, and (e) receiving a placement report of the first advertisement from the device. The light script is configured to place at least the first advertisement on the web page to be displayed on the device.

The present disclosure seeks to provide an apparatus for dynamically placing an advertisement on a web page. The apparatus includes a processor, and a memory that stores program codes. The program codes include a light script determination module, a light script selection module, a light script communication module, and a full script communication module. The light script determination module implemented by the processor determines whether a light script exists or not based on a first request for a script received from a device. The first request includes context information. The light script selection module implemented by the processor selects a matching light script based on the context information when the light script exists. The light script communication module implemented by the processor communicates the matching light script to the device when the light script matches with the first request. The full script communication module implemented by the processor communicates a full script to the device. The full script communication module communicates the full script to the device when (a) no matching light script that is suitable for the context information exists, or when (b) the apparatus receives a second request for the full script from the device.

The purpose of the light script is to place an advertisement quickly; the full script is substantially larger in size and executes much slowly than the light script.

Embodiments of the present disclosure substantially eliminate or at least partially address the aforementioned problems in the prior art, and enables for serving an optimally sized script to a device for dynamically placing an advertisement that loads faster.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of one or more devices interacting with a script server for dynamically placing an advertisement on a web page, in accordance with an embodiment of the present disclosure;

FIG. 2 is an exploded view of the script server of FIG. 1, in accordance with an embodiment of the present disclosure;

FIG. 3 is an exploded view of a light script that is served by the script server and executed in the one or more devices of FIG. 1, in accordance with an embodiment of the present disclosure;

FIG. 4 is an exploded view of the full script that is served by the script server and executed in the one or more devices of FIG. 1, in accordance with an embodiment of the present disclosure;

FIGS. 5A-5B are interaction flow diagrams that illustrate an interaction between the one or more devices and the script server of FIG. 1, in accordance with an embodiment of the present disclosure;

FIGS. 6A-6B are flow diagrams that illustrate a backend process at the script server of FIG. 1 that learns which templates and related parameters/properties can be used in which situations, and when there is no need to send a full script at all, in accordance with an embodiment of the present disclosure;

FIGS. 7A-7B are flow diagrams that illustrate a method for dynamically placing an advertisement on a web page, in accordance with an embodiment of the present disclosure;

FIG. 8 is an exploded view of a receiver of FIG. 1, in accordance with an embodiment of the present disclosure; and

FIG. 9 illustrates a schematic diagram of computer architecture of the one or more devices, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, a method for dynamically placing an advertisement on a web page is provided. The method includes following steps of: (a) receiving a first request that includes context information from a device, (b) determining whether a light script that is suitable for the context information exists, (c) when the light script suitable for the context information exists, communicating the light script to the device, for placing the first advertisement on a web page followed by receiving a second request that includes context information from the device, or when no light script that is suitable for the context information exists, (d) communicating a full script to the device for analyzing content of the web page and for analyzing the correctness of the placement of the first advertisement on the web page, and (e) receiving a placement report of the first advertisement from the device. The light script is configured to place at least the first advertisement on the web page to be displayed on the device.

In an embodiment, the method further includes the step of: when the placement of the first advertisement after execution of the full script differs from the placement of the first advertisement after execution of the light script, as contained in the placement report, generating a modified light script based on the placement of the first advertisement after execution of the full script.

According to one embodiment, the method includes the step of: (i) receiving a third request that includes a second context information from a second device; and (ii) communicating the modified light script to the second device when the second context information matches with the first context information.

According to another embodiment, the context information is at least one information selected from the group comprising (a) a device make, (b) a browser make used by the device, (c) an Internet Protocol address associated with the device, (d) a language used by the browser, (e) a Uniform Resources Locator associated with the web page, or (f) an operating system used by the device. More than one information can be used, such as two, three, four, five or more information.

The context information allows operations, such as script selection, to be done based on environment. The use of Internet Protocol address as the context information allows script selection to be based on geographical location, such as country or town, as the geographical location may be deduced from the Internet Protocol address.

According to another embodiment, the light script is executed by a browser in the device and the light script is optimized to execute faster than the full script the positioning of the first advertisement in a location on an upper region of the web page, and the light script sends the second request for the full script and loads the full script.

In another embodiment, the light script is configured to execute in a substantially optimized manner to get the first advertisement placed quickly on the web page.

According to another embodiment, the full script is loaded by the light script and is executed by the browser in the device and the full script (i) analyses a structure of the web page, (ii) determines if there is at least one incorrectly placed advertisement that was placed by the light script on the web page and when the at least one incorrectly placed advertisement exists, corrects the at least one incorrectly placed advertisement that was placed by the light script on the web page, (iii) when a second advertisement to be placed exists, creates the second advertisement in the web page, and (iv) creates a placement report.

According to another embodiment, the light script that is suitable for the device is selected from a light script database that includes one or more different light scripts, wherein the light script that is suitable for the device is selected from the different light scripts based on rules that associate the different light scripts with different combinations of context information.

According to another embodiment, the placement report includes at least one of (i) location data about where on the web page advertisements were positioned, (ii) attributes which could have impacted the location data, or (iii) whether and by how much the full script modified a placement that was made by the light script, of at least one advertisement on the web page.

According to another embodiment, the placement report includes steps of: (i) generating a modified light script based on the attributes which could have impacted the location data, and (ii) generating a rule that associates the modified light script with the attributes which could have impacted the location data.

According to another embodiment, the method includes steps of: (i) determining a success rate of each of one or more light scripts each associated with a combination of context information, (ii) storing a best light script with a best success rate among the one or more light scripts associated with the combination of context information, and (iii) determining whether the best light script can be used without the full script.

According to another embodiment, the light script includes XPath information, and the light script selects at least one element on the web page based on the XPath information and places the first advertisement on the web page to be displayed on the device.

According to another embodiment, the light script includes a coordinate calculation function to place the first advertisement on the web page. The coordinate calculation function calculates a coordinate to place the first advertisement, and the first advertisement has a Cascading Style Sheet position property set to an absolute value.

In another aspect, one or more non-transitory computer readable storage mediums storing one or more sequences of instructions, which when executed by one or more processors, causes dynamically placing an advertisement on a web page, the instructions being configured to perform the steps of: (a) receiving a first request that includes context information from a device, (b) determining whether a light script that is suitable for the context information exists, (c) when the light script suitable for the context information exists, communicating the light script to the device, for placing the first advertisement on the web page followed by receiving a second request that includes context information from the device, or when no light script that is suitable for the context information exists, (d) communicating a full script to the device for analyzing content of the web page and for analyzing the correctness of the placement of the first advertisement on the web page, and (e) receiving a placement report of the first advertisement from the device. The light script is configured to place at least the first advertisement on the web page to be displayed on the device.

In another aspect, an apparatus for serving an optimally sized script to a device for placing an advertisement is provided. The apparatus includes a processor, and a memory that stores program codes. The program codes include a light script determination module, a light script selection module, a light script communication module, and a full script communication module. The light script determination module implemented by the processor determines whether a light script exists or not based on a first request for a script received from a device. The first request includes context information. The light script selection module implemented by the processor selects a matching light script based on the context information when the light script exists. The light script communication module implemented by the processor communicates the matching light script to the device when the light script matches with the first request. The full script communication module implemented by the processor communicates a full script to the device. The full script communication module communicates the full script to the device when (a) no matching light script that is suitable for the context information exists, or when (b) the apparatus receives a second request for the full script from the device.

In one embodiment, the program codes further include a light script modification module implemented by the processor that generates a modified light script based on a set of attributes that could have impacted location data on a position of at least one advertisement on the web page. The set of attributes that could have impacted the location data are identified in a placement report received from the device.

According to another embodiment, the program codes further include a light script rule generation module implemented by the processor that generates a rule that associates the modified light script with the attributes that could have impacted the location data.

According to another embodiment, the program codes further include a light script success determination module implemented by the processor that (i) determines a success rate of each of one or more light scripts each associated with a combination of context information, (ii) stores a best light script with a best success rate among the one or more light scripts associated with the combination of context information and (iii) determines whether the best light script can be used without the full script.

According to another embodiment, the light script selection module selects a matching light script based on the context information from a light script database that includes one or more different light scripts. The light script that is suitable for the device is selected from the different light scripts based on rules that associate the different light scripts with different combinations of context information. The context information is at least one information selected from the group comprising (a) a device make, (b) a browser make used by the device, (c) an Internet Protocol address associated with the device, (d) a language used by the browser, (e) a Uniform Resource Locator associated with the web page, or (e) an operating system used by the device.

According to another embodiment, the program codes further include a light script construction module implemented by the processor that constructs the light script based on (i) an XPath information or (ii) a coordinate calculation function to place a first advertisement on the web page. The coordinate calculation function may calculate a coordinate to place the first advertisement on the web site and the first advertisement has a Cascading Style Sheet position property set to an absolute value.

According to another embodiment, the full script is loaded by the light script and is executed by the browser in the device and the full script includes (i) a web page analysis module that analyses a structure of the web page in detail, (ii) a placement correction module that corrects incorrectly placed advertisements on the web page, and a placement report creation module that creates a placement report that includes at least one of (i) location data about where on the web page advertisements were positioned, (ii) attributes which could have impacted the location data, or (iii) whether and by how much the full script modified a placement that was made by the light script, of at least one advertisement on the web page.

In an embodiment, the advertisement may be a creative content. In another embodiment, the advertisement may be an advertisement tag of an advertising server or a publisher server, the advertisement tag being configured to execute the retrieval and placement of the advertisement.

The matching light script may be selected from a light script database that includes one or more different light scripts based on the context information when the light script exists. The one or more light scripts may be generated based on at least one of (a) Cascaded style sheets selector approach, (b) an Xpath information approach, (c) an x and y coordinate based on a screen of the one or more devices approach, or (d) a coordinate based on a parent DIV tag (e.g., a container that includes page elements) of the script based approach.

In the Cascaded style sheets selector based approach, the Class, element ID, etc. may be used to select an element and draw an advertisement synchronously based on the selected element. In the Xpath information based approach, an element (e.g., a node) may be selected based on XPath information (e.g., a location path including node tests) and the advertisement may be drawn based on the selected element. In the Cascaded style sheets selector based approach and the Xpath based approach, one sample may be sufficient to generate script from this template. In the x and y coordinate on screen based approach, there is no element selected, and the advertisement is just created with a position property set to an absolute value. This may requires many samples to fit into formulas, such as x=kw+c and y=Kh+C. In the coordinate based on a parent DIV tag approach, the advertisement is placed based on a location of the DIV tag where the script is injected.

A script analysis database may include information on where the light script is placed in a document object model and the parent nodes' position properties (e.g., first non-static) to verify whether a position:absolute origin is correct or not. The cascading style sheets properties of the element in which the light script tag is placed as well as all the parents are obtained to determine to what x and y coordinates are relative to, in case the light script creates an advertisement according to x and y coordinates. Also the light script is used where the advertisement is created as a hyper text markup language element with the cascading style sheets property “position: absolute”, and the x and y coordinates are counted from the first non-static parent. The script analysis database may further include information on whether the light script is able to create the advertisement in the correct location or how much the light script went wrong and information on whether the full script is needed at all, and dimensions/attributes/context information such as (i) an uniform resources locator of the browser used, (ii) the one or more devices type, (iii) a browser make, (iv) an operating system make, (v) a country of location of the one or more devices, and/or (vi) a browser language of the one or more devices.

The present disclosure provides an apparatus, computer readable media, and a method that is used to serve an advertisement in a correct or a best effort optimum location on the web page using the light script. Since the light script is executed faster than a full script, and may also be smaller in size, a speed for serving the one or more advertisements in the web page is high. In one embodiment, the light script does not contain complex logic on how the best placements are “sniffed” and it is not validated against a large number of different rules.

According to an embodiment, the light script has a simpler logic to just create the advertisement on a best effort basis, while the full script has a complex and slower logic, which loops through most hyper text markup language nodes and evaluates whether it meets all criteria for being a placement for an advertisement based on many complex rules. The light script may reduce the execution time for placement of one or more advertisements by as much as 1/100, in one embodiment. In another embodiment, the light script may be less than half the size of the full script and even up to 1/100^{th} the size of the full script. The light script may include a loader functionality to load the full script, whenever the full script is required. A self-learning algorithm may be applied for making the system learn which properties or parameters can be used in which situations.

### DETAILED DESCRIPTION OF THE DRAWINGS

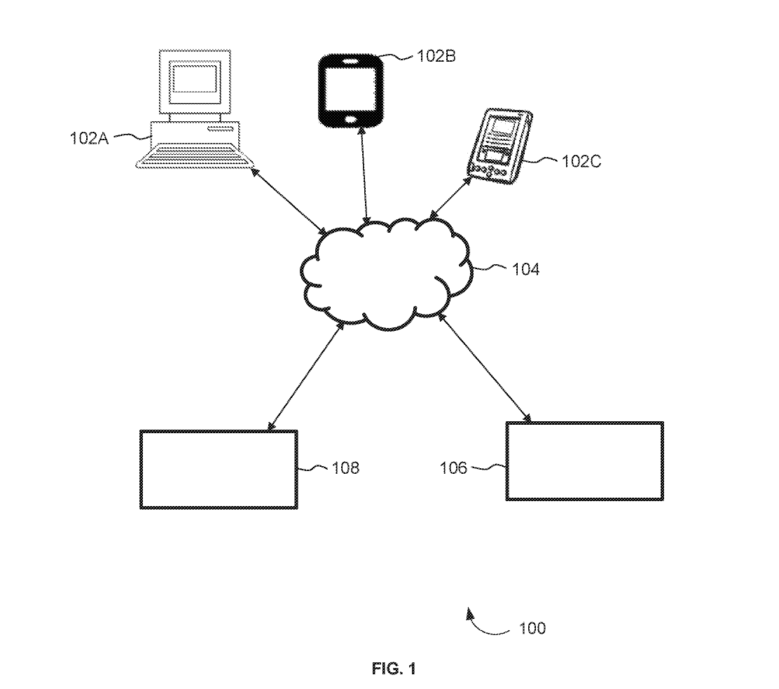

Referring to FIG. 1, illustrated is a schematic illustration 100 of one or more devices 102A-C interacting with a script server 106 for placing an advertisement on a web page, in accordance with an embodiment of the present disclosure. The schematic illustration 100 includes the one or more devices 102A-C, a network 104, the script server 106, and an advertisement publisher server 108. In an embodiment, the one or more devices 102A-C may be a desktop, a mobile phone, a smart phone, a tablet, a personal computer, and an electronic notebook, etc. The one or more devices 102A-C executes one or more web browsers. The advertisement publisher server 108 serves the web browser that includes web content to the one or more devices 102A-C via the network 104. In an embodiment, the network 104 may be a wired network, a wireless network, a local area network, etc. The web content includes script tags that cause interaction between the one or more devices 102A-C, and the script server 106. The script server 106 serves an optimally sized script for placing the advertisement in the correct location on the web page displayed on the one or more devices 102A-C via the network 104.

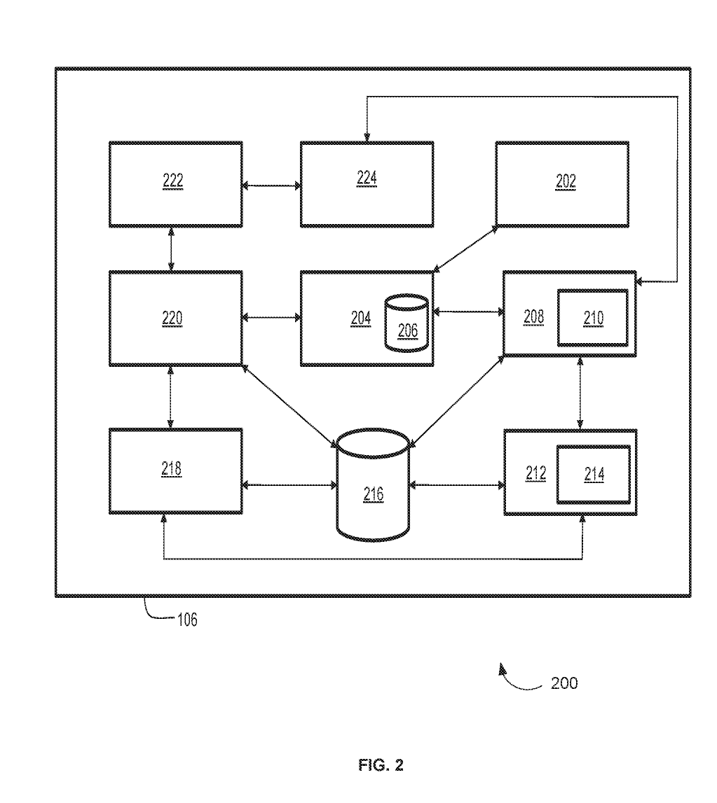

Referring to FIG. 2, illustrated is an exploded view 200 of the script server 106 of FIG. 1, in accordance with an embodiment of the present disclosure. The exploded view 200 includes a light script determination module 202, a light script selection module 204, a light script communication module 208, a full script communication module 212, a script analysis database 216, a light script modification module 218, a light script rule generation module 220, a light script success determination module 222, and a light script construction module 224. The light script selection module 204 includes a light script database 206 that includes one or more different light scripts associated with one or more combinations of context information. The light script communication module 208 includes a light script 210. The full script communication module 212 includes a full script 214.

The light script determination module 202 is configured to determine whether the light script 210 exists or not based on a first request for a script received from the one or more devices 102A-C. The first request includes context information. The context information may be selected from a group including (a) make of the one or more devices 102A-C, (b) a browser make used by the one or more devices 102A-C, (c) a country in which the one or more devices 102A-C are used, the country being decoded from the Internet Protocol address associated with the one or more devices (d) a language used by the browser, (e) a Uniform Resource Locator associated with the web page, or (e) an operating system used by the one or more devices 102A-C. The light script selection module 204 is configured to select a matching light script based on the context information when the light script 210 exists.

In case the script server 106 does not contain a close match, the light script selection module 204 may either return the closest matching light script that is present or may not return any light script 210 if the light script 210 that is present is not suitable for or does not match with the context information in the request. In an embodiment, the light script selection module 204 may further generate the light script 210 from the select template using attributes such as the x and y coordinates, width, height, and cascading style sheets etc. Further, the light script selection module 204 is configured to select a matching light script that is suitable for the one or more devices 102A-C selected from the different light scripts based on rules that associate the different light scripts with different combinations of context information.

The light script communication module 208 is configured to communicate the matching light script 210 to the one or more devices 102A-C when the light script 210 matches with the first request. The full script communication module 212 is configured to communicate the full script 214 to the one or more devices 102A-C when (a) no matching light script that is suitable for the context information exists, or when (b) the script server 106 receives a second request for the full script 214 from the one or more devices 102A-C. In an embodiment, the full script 214 is substantially larger in size than the light script 210 and the full script 214 includes more complex logic on placement sniffing. The full script 214 may include complex slower logic, which loops through many hyper text markup language nodes and evaluates whether the nodes meet a large number of criteria and complex rules for placing an advertisement.

The script analysis database 216 may store placement reports received from the one or more devices 102A-C. In an embodiment, the script analysis database 216 may include data on (i) x- and y-coordinates where the first advertisement is created, (ii) width and height of the web page, (iii) an XPath to advertisement placement, and (iv) an element identity, cascading style sheets classes, etc. The light script modification module 218 is configured to generate a modified light script based on a set of attributes, which could have impacted location data on a position of at least one advertisement on the web page. The set of attributes that could have impacted the location data may be identified in a placement report received from the one or more devices 102A-C and stored in the script analysis database 216.

The light script rule generation module 220 may be configured to generate a rule that associates the modified light script with the attributes that could have impacted the location data. In one embodiment, the light script success determination module 222 is configured to (i) determine a success rate of each of one or more light scripts each associated with a combination of context information, (ii) store a best light script with a best success rate among the one or more light scripts associated with the combination of context information, and (iii) determine whether the best light script can be used without the full script 214. The light script construction module 224 may be configured to construct the light script based on (i) an XPath information or (ii) a coordinate calculation function to place a first advertisement on the web page. The coordinate calculation function may calculate a coordinate to place the first advertisement based on at least one of a location of an element that has a Cascading Style Sheet position property set to an absolute value.

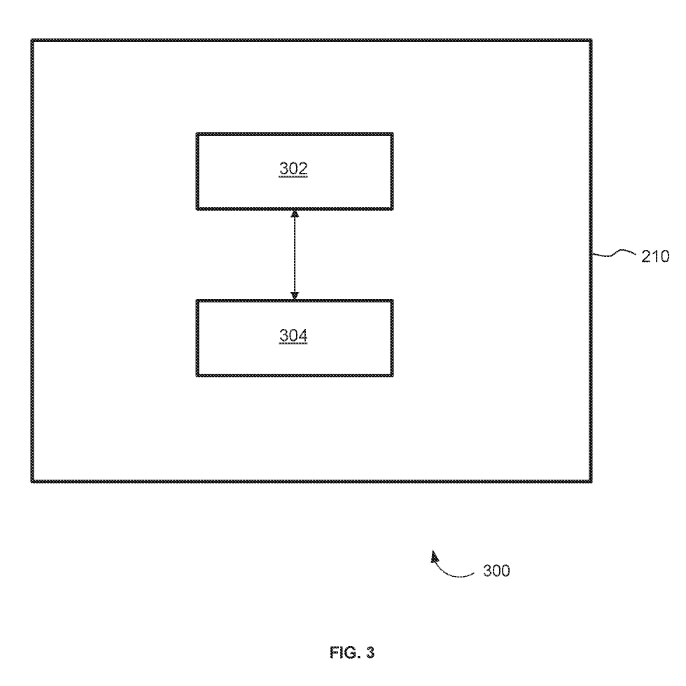

Referring to FIG. 3, illustrated is an exploded view 300 of the light script 210 that is stored in the script server 106 of FIG. 1 and executed in the one or more devices 102A-C of FIG. 1, in accordance with an embodiment of the present disclosure. The exploded view 300 includes a first advertisement creation module 302, and a full script request module 304. The first advertisement creation module 302 is configured to create a first advertisement when the light script 210 is received from the script server 106. The full script request module 304 is configured to send a request (e.g., that includes context information) for the full script 214 to the script server 106. The full script request module 304 may also load and execute the full script 214 on one of the devices 102A-C.

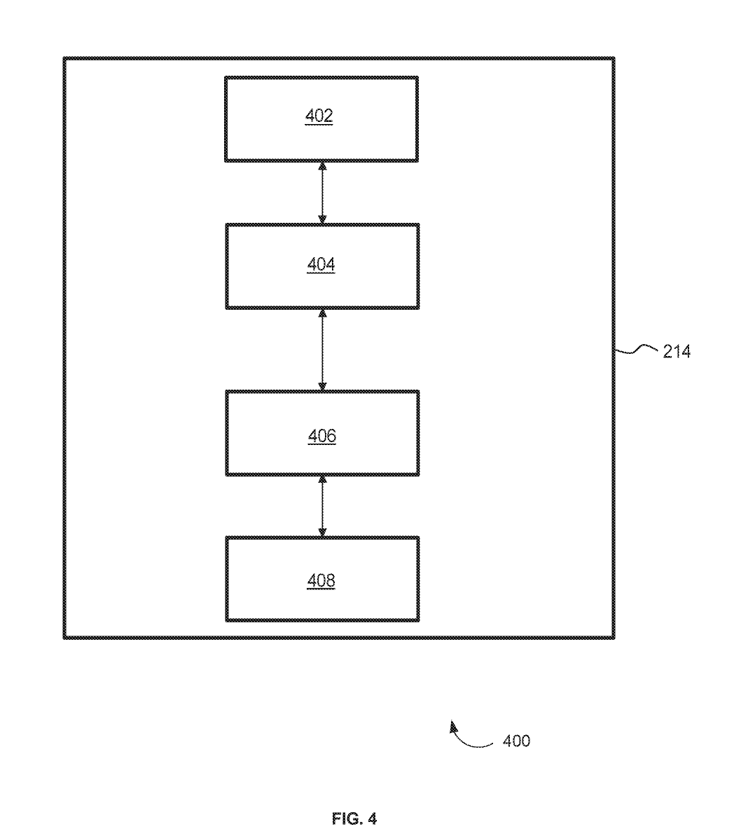

Referring to FIG. 4, illustrated is an exploded view 400 of the full script 214 that is served by the script server 106 and executed in the one or more devices 102A-C of FIG. 1, in accordance with an embodiment of the present disclosure. The exploded view 400 includes a web page analysis module 402, a placement correction module 404, a second advertisement creation module 406, and a placement report creation module 408. The web page analysis module 402 is configured to analyze a structure of the web page in detail. The placement correction module 404 is configured to determine if there is at least one incorrectly placed advertisement that was placed by the light script on the web page and when the at least one incorrectly placed advertisement exists, corrects the at least one incorrectly placed advertisements on the web page. The second advertisement creation module 406 is configured to create a second advertisement in the web page, when the second advertisement to be placed exists. The placement report creation module 408 is configured to create a placement report that includes at least one of (i) location data about where on the web page advertisements were positioned, (ii) attributes which could have impacted the location data, or (iii) whether and by how much the full script 214 modified a placement that was made by the light script 210, of at least one advertisement on the web page.

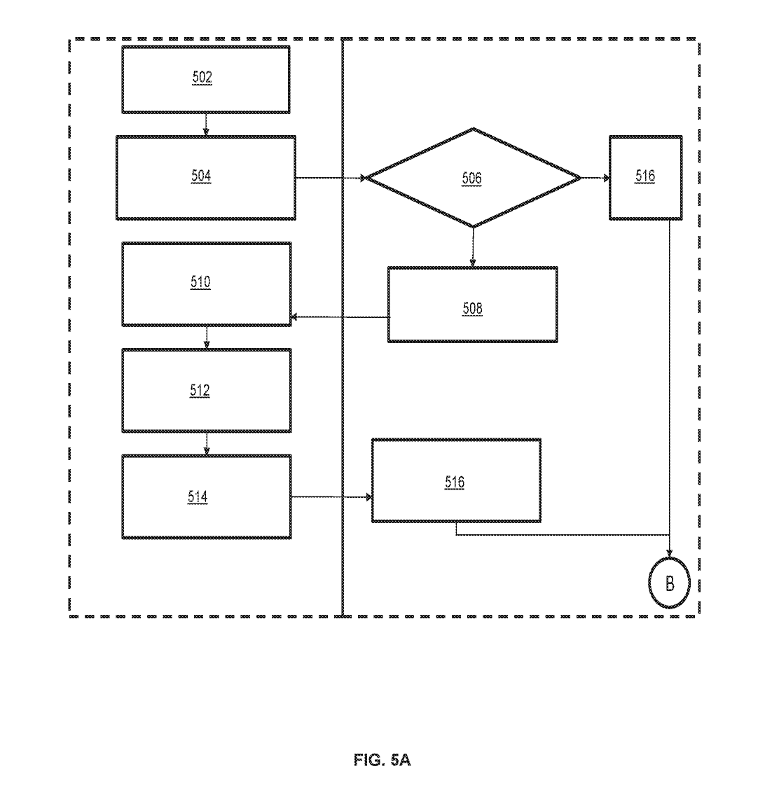

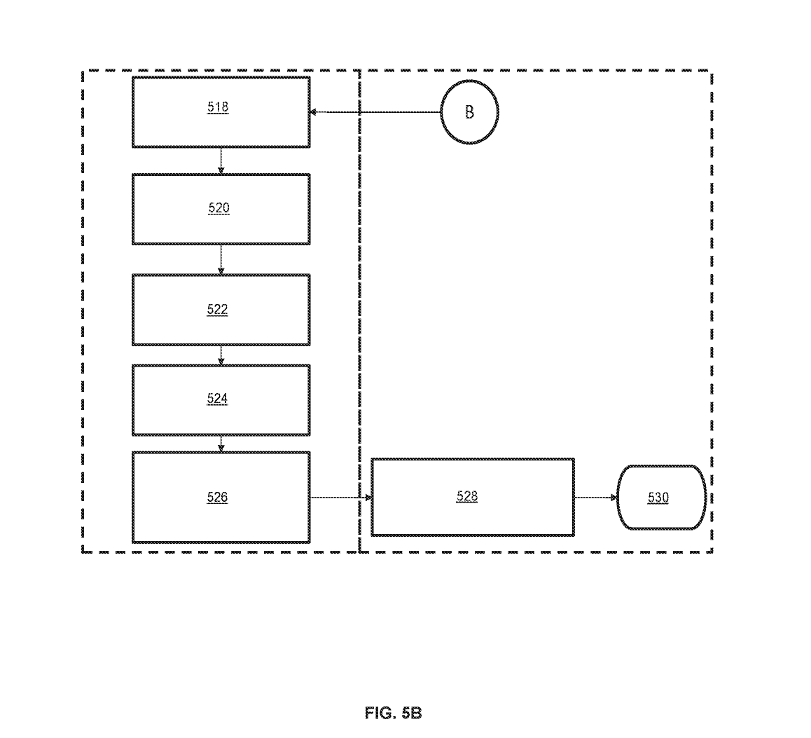

Referring to FIGS. 5A-5B, illustrated are interaction flow diagrams that illustrate an interaction between the one or more devices 102A-C, and the script server 106 of FIG. 1, in accordance with an embodiment of the present disclosure. At step 502, the one or more devices 102A-C load a web page of content. At step 504, a first request is sent for a script using an embedded code of the web page of the one or more devices 102A-C to the script server 106. In an embodiment, the first request includes context information. At step 506, it is determined whether the light script 210 that is suitable for the context information exists. At step 508, the matching light script 210 is communicated to the one or more devices 102A-C when the light script 210 matches with the first request. At step 510, the matching light script 210 is received from the script server 106 to the one or more devices 102A-C. At step 512, a first advertisement is created using the matching light script 210. At step 514, a second request is sent to the script server 106 for a full script 214 using the light script 210.

At step 516, the full script 214 is communicated to the one or more devices 102A-C when (a) no matching light script that is suitable for the context information exists, or when (b) the script server 106 receives the second request from the one or more devices 102A-C. At step 518, the full script 214 is received from the script server 106. At step 520, a structure of the web page is analyzed in detail using the full script 214. At step 522, at least one incorrectly placed advertisement that was placed by the light script on the web is determined and when the at least one incorrectly placed advertisement exists, the at least one incorrectly placed advertisement that was placed by the light script on the web page is corrected. At step 524, a second advertisement is created in the web page when the second advertisement to be placed exists. At step 526, a placement report is sent to the script server 106 from the one or more devices 102A-C using the full script 214. At step 528, the placement report is received from the one or more devices 102A-C to the script server 106 and stored the script analysis database 216. The placement report includes at least one of (a) location data about where on the web page advertisements are positioned, and (b) (ii) attributes which could have impacted the location data, or (iii) whether and by how much the full script modified a placement that was made by the light script, of at least one advertisement on the web page and the process ends at step 530.

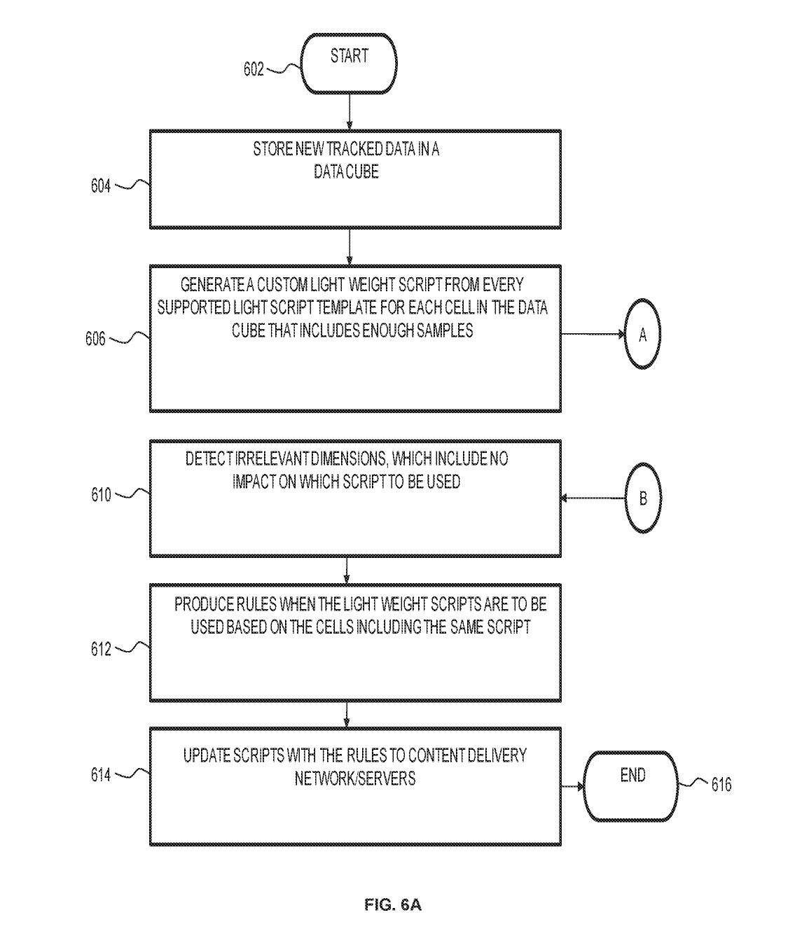

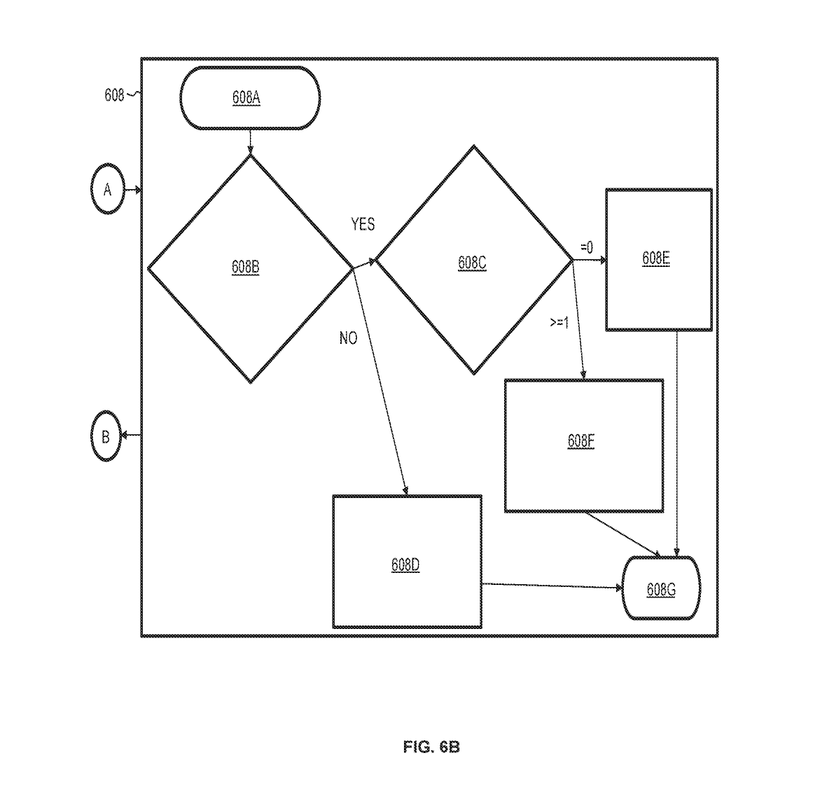

Referring to FIGS. 6A-6B, illustrated are flow diagrams that illustrate a backend process at the script server 106 of FIG. 1 that learns which templates and related parameters/properties can be used in which situations, and when there is no need to send a full script at all, in accordance with an embodiment of the present disclosure. The process starts at step 602. At step 604, new tracked data using the full script 214 is stored in a data cube. At step 606, a custom lightweight script is generated from every supported light script template for each cell in the data cube that includes enough samples. At step 608, the steps 608A-G are iterated for each cell. At step 608A, the process starts with iteration over one cell. At step 608B, it checks whether there is enough success/failure data for all scripts to be statistically relevant or not. If the success/failure data is statistically relevant for all the scripts, a number of generated scripts that meet success rate threshold are determined at step 608C.

If the success/failure data are not statistically relevant for all the scripts, all information and scripts for which experimentation is needed are kept to determine a best script at step 608D. The light script 210 is not used when none of the generated scripts meet with the success rate threshold at step 608E. At step 608F, a most successful script is selected and it is determined whether any of the generated scripts can be used without full script 214 at all. The iteration process ends at step 608G. The success rate may be determined based on a ratio of successful attempts to place the one or more advertisements with the light script to the total number of attempts. At step 610, irrelevant dimensions are detected which includes no impact on which script to be used. At step 612, rules are produced on when the lightweight scripts are to be used based on the cells including the same script. At step 614, the scripts with the rules are updated to a content delivery network/servers and the process ends at step 616.

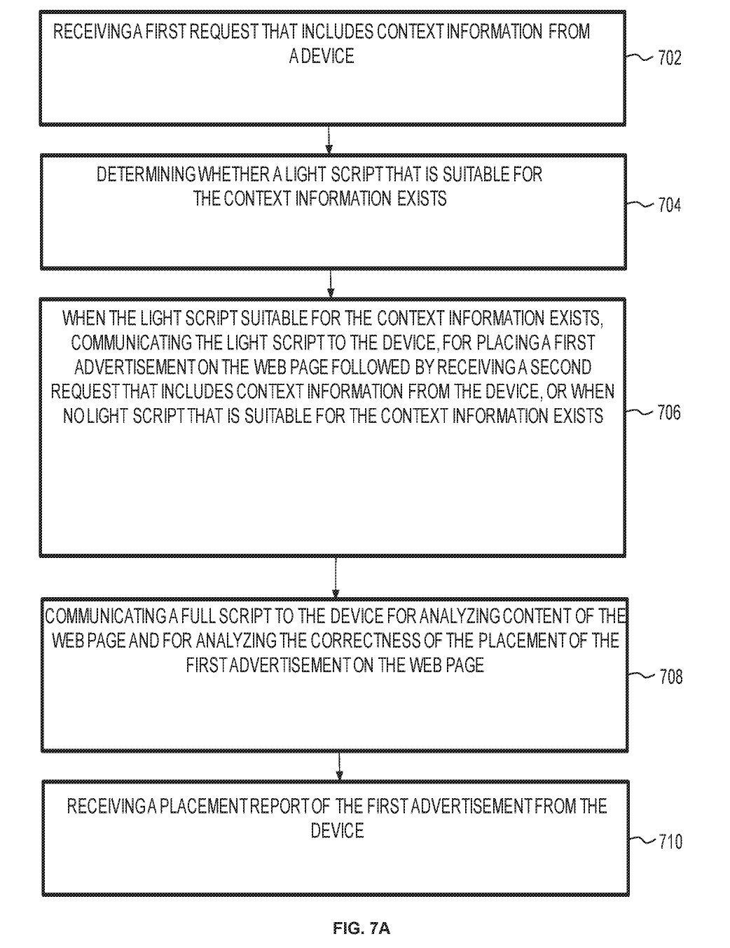

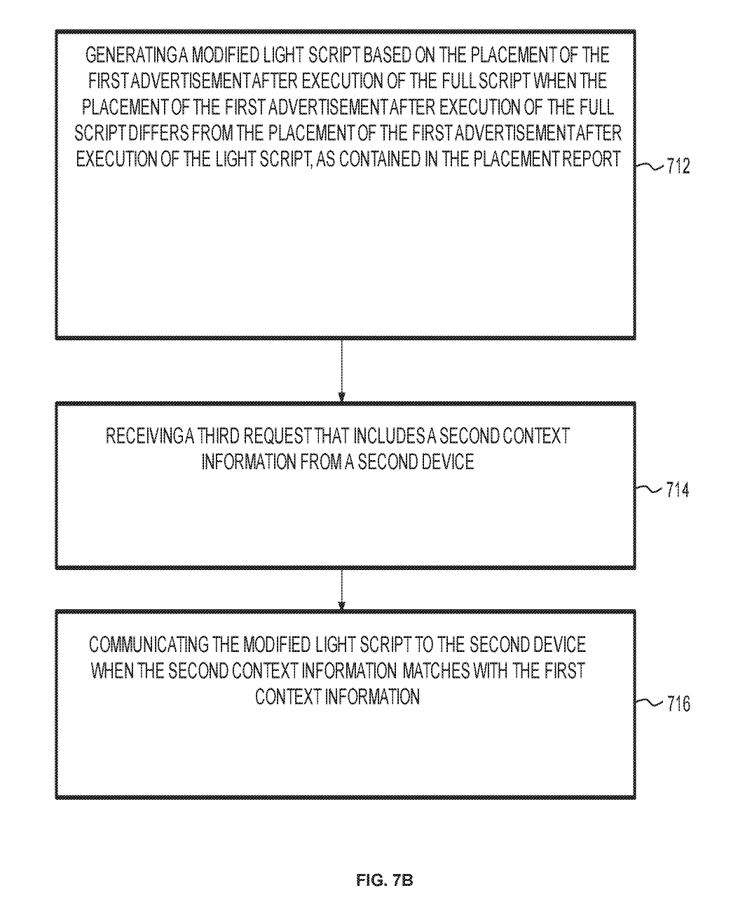

Referring to FIG. 7A, illustrated is a flow diagram that illustrates a method for dynamically placing an advertisement on a web page, in accordance with an embodiment of the present disclosure. At step 702, a first request is received from one or more devices 102A-C. The first request includes context information. At step 704, a light script 210 that is suitable for the context information, is determined whether the light script 210 exists based on the context information. In an embodiment, the light script 210 is configured to place at least a first advertisement on the web page to be displayed on the one or more devices 102A-C.

At step 706, the light script 210 that is suitable for the context information, is communicated to the one or more devices 102A-C when the light script 210 that is suitable for the context information exists, for placing the first advertisement on the web page followed by receiving a second request that includes context information from the one or more devices 102A-C, or when no light script that is suitable for the context information exists. At step 708, a full script 214 is communicated to the one or more devices for analyzing content of the web page and for analyzing the correctness of the placement of the first advertisement on the web page. At step 710, a placement report of the first advertisement is received from the one or more devices 102A-C.

Referring to FIG. 7B, illustrated is a flow diagram that illustrates the method that further includes steps for dynamically placing the advertisement on the web page of FIG. 7A, in accordance with an embodiment of the present disclosure. At step 712, a modified light script is generated based on the placement of the first advertisement after execution of the full script when the placement of the first advertisement after execution of the full script differs from the placement of the first advertisement after execution of the light script, as contained in the placement report. At step 714, a third request is received from a second device 102B. The third request includes a second context information. At step 716, the modified light script is communicated to the second device 102B when the second context information matches with the first context information.

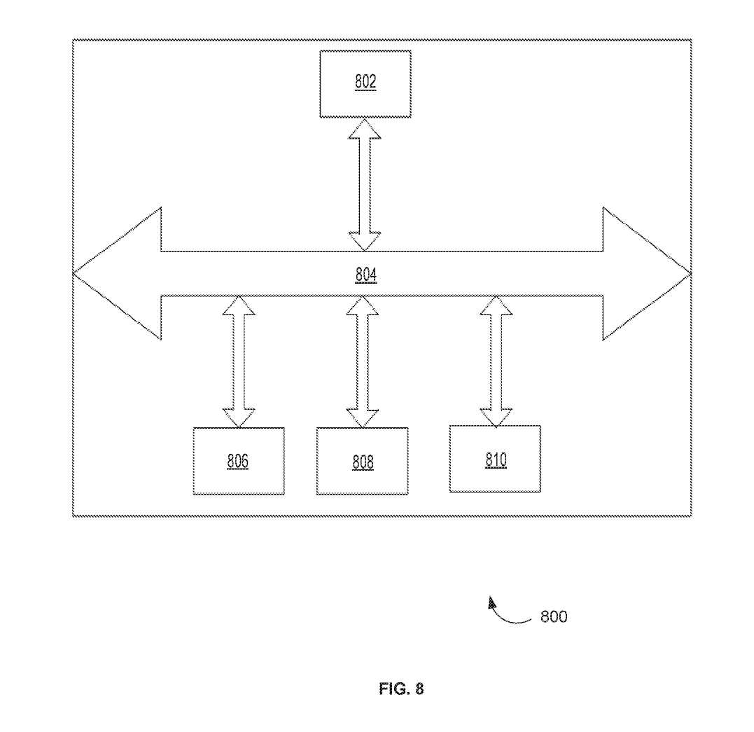

Referring to FIG. 8, illustrated is an exploded view of a receiver 800 of FIG. 1 having a memory 802 having a set of instructions, a bus 804, a display 806, a speaker 808, and a processor 810 capable of processing the set of instructions to perform any one or more of the methodologies herein, according to an embodiment herein. The processor 810 may also enable digital content to be consumed in the form of video for output via one or more displays 806 or audio for output via speaker and/or earphones 808. The processor 810 may also carry out the methods described herein and in accordance with the embodiments herein.

Digital content may also be stored in the memory 802 for future processing or consumption. The memory 802 may also store program specific information and/or service information (PSI/SI), including information about digital content (e.g., the detected information bits) available in the future or stored from the past. A user of the receiver 800 may view this stored information on display 806 and select an item of for viewing, listening, or other uses via input, which may take the form of keypad, scroll, or other input device(s) or combinations thereof. When digital content is selected, the processor 810 may pass information. The content and PSI/SI may be passed among functions within the receiver 800 using the bus 804.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

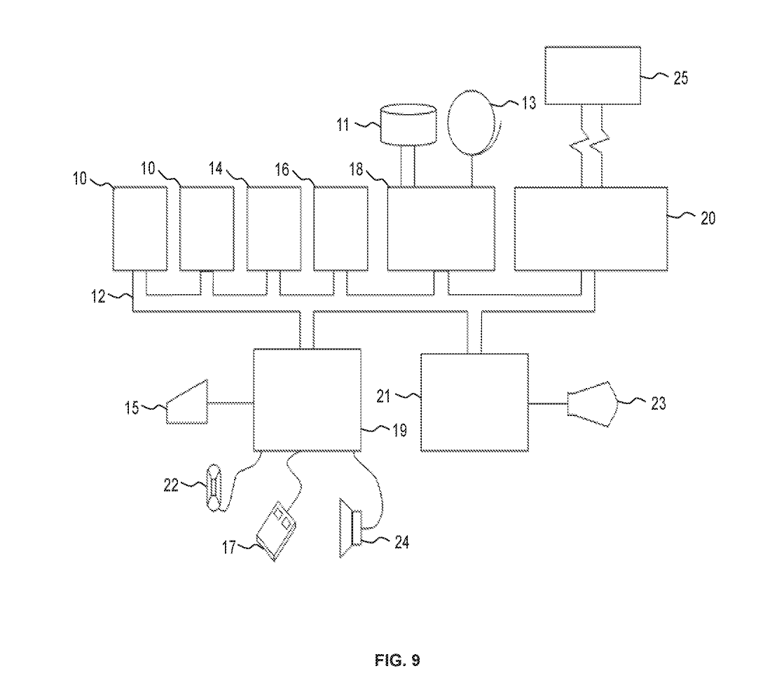

A representative hardware environment for practicing the embodiments herein is depicted in FIG. 9. This schematic drawing illustrates a hardware configuration of a computer architecture/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

### EXAMPLES

### Example 1

The placement report received by the script server 106 includes data structures. For example, if the x and y coordinate value of the context information is 240 and 300 respectively. The x and y coordinate value of the light script may be 238 and 299 respectively. The x and y coordinate value of the light script is not matched with the x and y coordinate value of the context information. Hence, the full script is needed on the web page and the light script needs to be revised based on the feedback from the placement report. The data structure for the example of coordinate values is given below.

```
var Event = {
  ‘firstNonStaticNode’: ‘body’, // From which element coordinates
  ‘x’: 240, // Correct x-coordinate for ad
  ‘y’: 300, // Correct y-coordinate for ad
  ‘xL’: 238, // x-coordinate where light script placed the ad
  ‘yL’: 299, // y-coordinate where light script placed the ad
  ‘width’: 1080,
  ‘height’: 720,
  ‘cssTarget’: ‘#articlePic’,
  ‘fullScriptNeeded’: true, // Whether the full script was needed on that
  page
  ‘lightScriptTemplateUsed’: ‘PosAbsoluteScriptTemplate’,
  ‘lightScriptRevisionUsed’: 32321321 // Revision nr of light script to
associate events with the right script
};
```

### Example 2

The backend process may use the data cube to work with tracked data. The data cube can be used to check every dimension whether the data cube includes impact on the variables in the cells, which includes the impact on the actual light script 210 served to the one or more devices 102A-C. The data cube is a three dimensional cube with dimensions of (a) an uniform resources locator associated with the web page, (b) a browser make used by the one or more devices 102A-C, and (c) the one or more devices 102A-C make. The data structures used for the example data cube with the three dimensions are given below.

```
vardataCube = {
‘example.com/some-article.html’: {
    ‘Firefox’: {
      ‘mobile’: {
        ‘events’: [ ], // Event objects
        ‘meta’: { } // Meta information populated by process
      },
      ‘desktop’: {
        ‘events’: [ ], // Event objects
        ‘meta’: { } // Meta information populated by process
      },
      ‘tablet’: {
        ‘events’: [ ], // Event objects
        ‘meta’: { } // Meta information populated by process
      }
    },
    ‘Chrome’: {
      ‘mobile’: {
        ‘events’: [ ], // Event objects
        ‘meta’: { } // Meta information populated by process
      },
      ‘desktop’: {
        ‘events’: [ ], // Event objects
        ‘meta’: { } // Meta information populated by process
      },
      ‘tablet’: {
        ‘events’: [ ], // Event objects
        ‘meta’: { } // Meta information populated by process
      }
    }
  },
  ‘example.com/other-page.html’: {
    ‘Firefox’: {
      ‘mobile’: {
        ‘events’: [ ], // Event objects
        ‘meta’: { } // Meta information populated by process
      },
      ‘desktop’: {
        ‘events’: [ ], // Event objects
        ‘meta’: { } // Meta information populated by process
      },
      ‘tablet’: {
        ‘events’: [ ], // Event objects
        ‘meta’: { } // Meta information populated by process
      }
    },
    ‘Chrome’: {
      ‘mobile’: {
        ‘events’: [ ], // Event objects
        ‘meta’: { } // Meta information populated by process
      },
      ‘desktop’: {
        ‘events’: [ ], // Event objects
        ‘meta’: { } // Meta information populated by process
      },
      ‘tablet’: {
        ‘events’: [ ], // Event objects
        ‘meta’: { } // Meta information populated by process
      }
    }
  }
}.
```

The data structures are given for the data cube with three dimensions. For example, the one or more devices 102A-C may use a firefox browser and/or the one or more devices 102A-C may use a chrome browser.

### Example: 3

The data structures used for selecting the best light script based on success rate using meta field in the data cube are given below.

```
varmeta = {
  ‘scripts’: [ ], // array of script objects
  ‘lightScriptCanBeUsed’: true,
  ‘bestScript’: {/*script obj*/} // NULL in case
no script met threshold and experimentation is still needed
};
```

### Example: 4

A script object is used to encapsulate data about the script. The script that is generated from the script template. The light script includes a revision so the tracking of context information can be analysed from which script revision. Also a time stamp is used to keep tracking when the light scripts are created and expired after some time. In another embodiment, a code field includes actual javascript code of the light script. In case the backend process had identified that under these conditions there is no need for the full script, then the code does not include instructions to load the full script at all (or alternatively the code could do to a load every 1/1000 times). The data structures used for the script objects are given below.

```
var Script = {
  ‘name’: ‘PosAbsoluteScript’,
  ‘revision’: 827387,
  ‘code’: ‘javascript code here...’,
  ‘createdTs’: 1451377025
};
```

### Example: 5

The script usage rules are instructions when a specific light script can be used. In an embodiment, the script usage rules include conditions separated by ANDs and ORs. The script array includes script objects that can be used conditions given below. For example, if the rule specifies the browser that is a firefox browser, then the server 106 suggests which of the light scripts can be used for the firefox browser.

varScriptUsageRule = {
‘rule’: ‘“browser” == “Firefox”’,
‘scripts’: [ ]
};

### Example: 6

The light script can be selected from one or more light scripts in the light script database 206 based on the success rate using the data structures given below.

```
functionbackendProcess( ) {
vartemplateScripts = [new PosAbsoluteScriptTemplate( ), new XPathScriptTemplate( )];
vardataCube = createCubeFromLoggedEvents( );
van, u, b, d, successRate, script, bestScript, bestSuccessRate, scriptUsageRules,
untestedScriptFound;
  // Loop over all cells
for (u = 0; u<dataCube.length; u++) {
for (b = 0; b<dataCube[u].length; b++) {
for (d = 0; d<dataCube[u][b].length; d++) {
bestScript = null;
bestSuccessRate = 0;
untestedScriptFound = false;
for (i = 0; i<templateScripts.length; i++) {
            script = dataCube[u][b][d].meta[‘scripts’][templateScripts[i].getName( )];
if (script == null || script.hasExpired( )) {
              script = templateScripts[i].generateLightScript(dataCube[u][b][d].events);
dataCube[u][b][d].meta[‘scripts’][templateScripts[i].getName( )] = script;
            }
successRate = script.getSuccessRate(dataCube[u][b][d].events);
if (successRate === false) { // Not enough events for success rate to be trusted
untestedScriptFound = true;
            }
if (successRate>bestSuccessRate) {
bestSuccessRate = successRate;
bestScript = script;
            }
          }
if (!untestedScriptFound) {
if (bestSuccessRate>= SUCCESS_RATE_THRESHOLD) {
dataCube[u][b][d].meta[‘bestScript’] = script;
lightScriptCanBeUsed = true;
            } else {
dataCube[u][b][d].meta[‘bestScript’] = null;
lightScriptCanBeUsed = false;
            }
          } else {
lightScriptCanBeUsed = true;
dataCube[u][b][d].meta[‘bestScript’] = null;
          }
      }
    }
  }
  // Check if meta info is same for a bigger set of cells and produce common rules for those
cells
scriptUsageRules = extractRules(dataCube); // returns ScriptUsageRule[ ]
deployScriptRules(scriptUsageRules);
}
```

For example, if the success rate is greater than or equal to the best success rate, the light script 210 can be the best light script, which is selected from the one or more light scripts.

1. A method for dynamically placing an advertisement on a web page, comprising:
receiving a first request that comprises context information from a device;
determining whether a light script that is suitable for context information exists, wherein the light script is configured to place at least a first advertisement on the web page to be displayed on the device;
when the light script suitable for the context information exists, communicating the light script to the device, for placing the first advertisement on the web page followed by receiving a second request that comprises context information from the device,
or, when no light script that is suitable for the context information exists;
communicating a full script to the device for analyzing content of the web page and for analyzing the correctness of the placement of the first advertisement on the web page; and
receiving a placement report of the first advertisement from the device.

2. The method according to claim 1, further comprising, when the placement of the first advertisement after execution of the full script differs from the placement of the first advertisement after execution of the light script, as contained in the placement report,
generating a modified light script based on the placement of the first advertisement after execution of the full script.

3. The method according to claim 1, further comprising
receiving a third request that comprises a second context information from a second device; and
communicating the modified light script to the second device when the second context information matches with the first context information.

4. The method according to claim 1, wherein the context information is at least one information selected from the group comprising (a) a device make, (b) a browser make used by the device, (c) an Internet Protocol address associated with the device, (d) a language used by the browser, (e) a Uniform Resources Locator associated with the web page, or (f) an operating system used by the device.

5. The method according to claim 1, wherein the light script is executed by a browser in the device and the light script is optimized to execute faster than the full script the positioning of the first advertisement in a location on an upper region of the web page, and the light script sends the second request for the full script and loads the full script.

6. The method according to claim 1, wherein the full script is loaded by the light script and is executed by the browser in the device and the full script (i) analyzes a structure of the web page, (ii) determines if there is at least one incorrectly placed advertisement that was placed by the light script on the web page and when the at least one incorrectly placed advertisement exists, corrects the at least one incorrectly placed advertisement that was placed by the light script on the web page, (iii) when a second advertisement to be placed exists, creates the second advertisement in the web page, and (iv) creates a placement report.

7. The method according to claim 1, wherein the light script that is suitable for the device is selected from a light script database that comprises a plurality of different light scripts, wherein the light script that is suitable for the device is selected from the different light scripts based on rules that associate the different light scripts with different combinations of context information.

8. The method according to claim 1, wherein the placement report comprises at least one of (i) location data about where on the web page advertisements were positioned, (ii) attributes which could have impacted the location data, or (iii) whether and by how much the full script modified a placement that was made by the light script, of at least one advertisement on the web page.

9. The method according to claim 8, further comprising
generating a modified light script based on the attributes which could have impacted the location data, and
generating a rule that associates the modified light script with the attributes which could have impacted the location data.

10. The method according to claim 1, further comprising
determining a success rate of each of a plurality of light scripts each associated with a combination of context information,
storing a best light script with a best success rate among the plurality of light scripts associated with the combination of context information, and
determining whether the best light script can be used without a full script.

11. The method according to claim 1, wherein the light script comprises XPath information, and the light script selects at least one element on the web page based on the XPath information and places the first advertisement on the web page to be displayed on the device.

12. The method according to claim 1, wherein the light script comprises a coordinate calculation function to place the first advertisement on the web page, wherein the coordinate calculation function calculates a coordinate to place the first advertisement based on a Cascading Style Sheet position property set to an absolute value.

13. One or more non-transitory computer readable storage mediums storing one or more sequences of instructions, which when executed by one or more processors, causes dynamically placing an advertisement on a web page, the instructions being configured to perform the steps of:
receiving a first request that comprises context information from a device;
determining whether a light script that is suitable for the context information exists, wherein the light script is configured to place at least a first advertisement on the web page to be displayed on the device;
when the light script suitable for the context information exists, communicating the light script to the device, for placing the first advertisement on the web page followed by receiving a second request that comprises context information from the device,
or, when no light script that is suitable for the context information exists;
communicating the full script to the device for analyzing content of the web page and for analyzing the correctness of the placement of the first advertisement on the web page; and
receiving a placement report of the first advertisement from the device.

14. An apparatus for dynamically placing an advertisement on a web page, comprising:
a processor; and
a memory that stores program codes comprising:
a light script determination module implemented by the processor that determines whether a light script exists or not based on a first request for a script received from a device, wherein the first request comprises context information;
a light script selection module implemented by the processor that selects a matching light script based on the context information when the light script exists;
a light script communication module implemented by the processor that communicates the matching light script to the device when the light script matches with the first request; and
a full script communication module implemented by the processor that communicates a full script to the device, wherein the full script communication module communicates the full script to the device when (a) no matching light script that is suitable for the context information exists, or when (b) the apparatus receives a second request for the full script from the device.

15. The apparatus according to claim 14, wherein the program codes further comprise a light script modification module implemented by the processor that generates a modified light script based on a set of attributes which could have impacted location data on a position of at least one advertisement on the web page, wherein the set of attributes which could have impacted the location data are identified in a placement report received from the device.

16. The apparatus according to claim 14, wherein the program codes further comprise a light script rule generation module implemented by the processor that generates a rule that associates the modified light script with the attributes that could have impacted the location data.

17. The apparatus according to claim 14, wherein the program codes further comprise a light script success determination module implemented by the processor that (i) determines a success rate of each of a plurality of light scripts each associated with a combination of context information, (ii) stores a best light script with a best success rate among the plurality of light scripts associated with the combination of context information and (iii) determines whether the best light script can be used without the full script.

18. The apparatus according to claim 14, wherein the light script selection module selects a matching light script based on the context information from a light script database that comprises a plurality of different light scripts, wherein the light script that is suitable for the device is selected from the different light scripts based on rules that associate the different light scripts with different combinations of context information, wherein the context information is at least one information selected from the group comprising (a) a device make, (b) a browser make used by the device, (c) an Internet Protocol address associated with the device, (d) a language used by the browser, (e) a Uniform Resource Locator associated with the web page, or (e) an operating system used by the device.

19. The apparatus according to claim 14, wherein the program codes further comprise a light script construction module implemented by the processor that constructs the light script based on (i) an XPath information or (ii) a coordinate calculation function to place a first advertisement on the web page, wherein the first advertisement has a Cascading Style Sheet position property set to an absolute value.

20. The apparatus according to claim 14, wherein the full script is loaded by the light script and is executed by the browser in the device and the full script comprises (i) a web page analysis module that analyses a structure of the web page in detail, (ii) a placement correction module that corrects incorrectly placed advertisements on the web page, and (iii) a placement report creation module that creates a placement report that includes at least one of (a) location data about where on the web page advertisements were positioned, (b) attributes which could have impacted the location data, or (c) whether and by how much the full script modified a placement that was made by the light script, of at least one advertisement on the web page.
